(19) United States
(12) Patent Application Publication
(10) Pub. No.: US 2026/0296775 A1
(43) Pub. Date: Oct. 1, 2026

(54) Garbage Can with Front Door for Simplified Bag Removal

(71) Applicant: Jason Davidson, Niagara Falls, NY (US)

(72) Inventor: Jason Davidson, Niagara Falls, NY (US)

(21) Appl. No.: 19/094,837

(22) Filed: Mar. 29, 2025

(51) Int. Cl. B65F 1/06; B65F 1/16

(52) U.S. Cl. CPC B65F 1/068; B65F 1/163

(57) ABSTRACT

A garbage can having a body with an internal region for containing refuse and a front panel with an integrated door providing access for garbage bag removal. Multiple closure mechanisms are provided for securing the door, and the body is adaptable to various applications, including residential, commercial, and industrial settings.

### BACKGROUND

The field of waste management and disposal systems has seen significant advances in design and functionality, particularly concerning the ease of use and user interaction with waste receptacles. Commonly, garbage cans are designed for top access, which is the point where waste is deposited and from where garbage bags are typically retrieved. While this design is prevalent and has been the standard for many years, it presents challenges, particularly when dealing with heavy or overfilled garbage bags.

Traditional top-access garbage cans necessitate lifting heavy bags vertically, which can be physically demanding and impractical for users with limited strength, mobility, or reach. The effort required to remove a full garbage bag is often compounded by the friction and added weight, especially when the bag is overfilled or contains non-compressible items. Furthermore, this method of bag removal can lead to a higher occurrence of bag punctures or tears, resulting in spills and unsanitary conditions. As urban environments grow and the demands on waste management systems increase, these issues persist, underscoring the need for a solution that simplifies the user experience while maintaining hygiene.

Current technologies and designs focus primarily on capacity and aesthetics, often overlooking the user's physical interaction with the garbage can during the bag removal process. Some designs attempt to mitigate this by using step-on mechanisms or increased bag support, yet they fail to address the fundamental issue of difficult access to the internal region of the bin. Furthermore, these solutions can increase manufacturing complexity and cost, thereby limiting their practicality for widespread implementation in residential, commercial, and industrial applications.

What is needed is a mechanism that provides enhanced access to the interior of a garbage can through an alternative entry point, such as a front-facing door. By facilitating easier and less physically demanding removal of heavy or overfilled garbage bags, this approach directly addresses the issues associated with traditional garbage can designs—streamlining the disposal process, reducing physical strain on the user, and minimizing the risk of spills and contamination. Such an innovation would not only improve user convenience and safety but would also potentially decrease maintenance requirements and increase the overall efficiency of waste management systems.

### FIELD

The field relates to waste management systems, specifically garbage receptacles with design modifications that facilitate the removal of waste bags through improved access mechanisms. It encompasses technology associated with the integration of access doors into the structure of garbage cans to optimize ease of use and user ergonomics.

### SUMMARY

In one aspect, the described technology pertains to an improved garbage can structure comprising a body with an integrated front-panel door. This door facilitates access to the internal region, thereby enhancing the ease of garbage bag removal. The integration of the door into the front panel of the garbage can allows for direct access to the contents, which simplifies the process of extracting overstuffed or heavy garbage bags compared to traditional top-access designs.

One objective of the described garbage can design is to improve user convenience and reduce the physical effort associated with removing overfilled garbage bags. By providing unobstructed access through the front-panel door, the structural modification addresses common challenges encountered with conventional garbage cans, thus potentially enhancing user safety and efficiency in waste disposal.

In an embodiment, the garbage can includes various closure mechanisms for maintaining the front door in a closed position when not in use. These closure mechanisms might include a latch mechanism, a friction fit closure, a magnetic closure, or a loop-style closure. Each option provides a secure method for ensuring the door remains closed, preserving the cleanliness and functionality of the garbage can.

In yet another aspect, the body of the garbage can may be adapted to various predetermined shapes and configurations suitable for different applications, such as residential, commercial, or industrial environments. This adaptive design allows for flexibility in use based on specific user needs or situational requirements, further enhancing the practicality and versatility of the garbage can system.

### BRIEF DESCRIPTION OF THE DRAWINGS

FIG. 1 is a perspective view of a garbage can assembly, illustrating the lid, receptacle, door, door fastener, and foot bar.

FIG. 2 is a perspective view of a garbage can with an open lid, featuring a receptacle and a door with a hook closure.

FIG. 3 is a perspective view of a garbage can assembly, illustrating various components including a lid, receptacle, door, hook closure, eye gate, and foot bar.

FIG. 4 is a perspective view of a garbage can with an open lid and a door mechanism.

FIG. 5 is a perspective view of a garbage can with an open door and door fastener.

### DETAILED DESCRIPTION

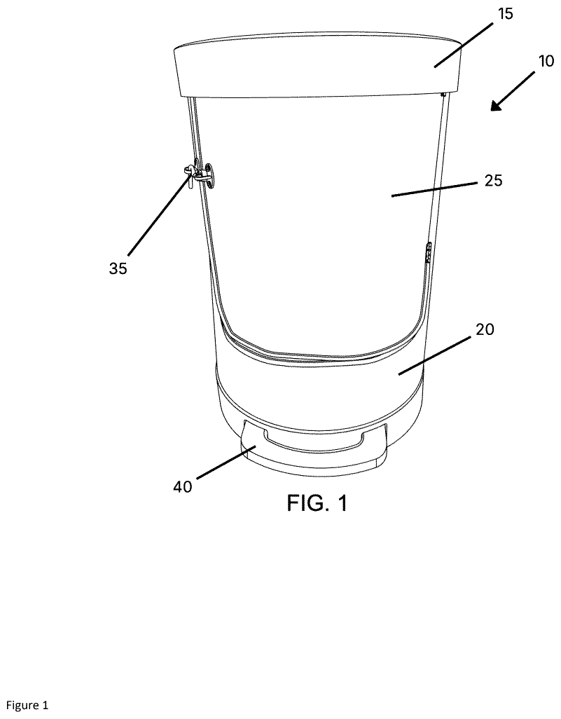

FIG. 1 shows a perspective view of a garbage can 10 incorporating a front door mechanism for enhanced access. The garbage can 10 comprises a lid 15 positioned at the top, serving as a closure mechanism for the receptacle 20. The receptacle 20 constitutes the main body of the garbage can, providing the internal space required to hold waste materials.

The figure illustrates a door 25 integrated into the receptacle 20. This door 25 is configured to allow direct access to the interior of the receptacle 20, facilitating the removal of garbage bags, particularly when they are overfilled. The door 25 is maintained in a secure closed position by a door fastener 35, which can be one of several potential closure mechanisms designed to ensure the door remains closed when not in use.

At the base of the garbage can 10, a foot bar 40 is depicted. The foot bar 40 may provide users with an ergonomic means to assist in opening the door 25, thereby enhancing user convenience and minimizing physical strain. This design allows for variability in the construction and operation of the door mechanism, accommodating a range of potential user needs and preferences. It is noted that foot bar 40 is optional and is not required for a fully functional garbage can 10 with door 25.

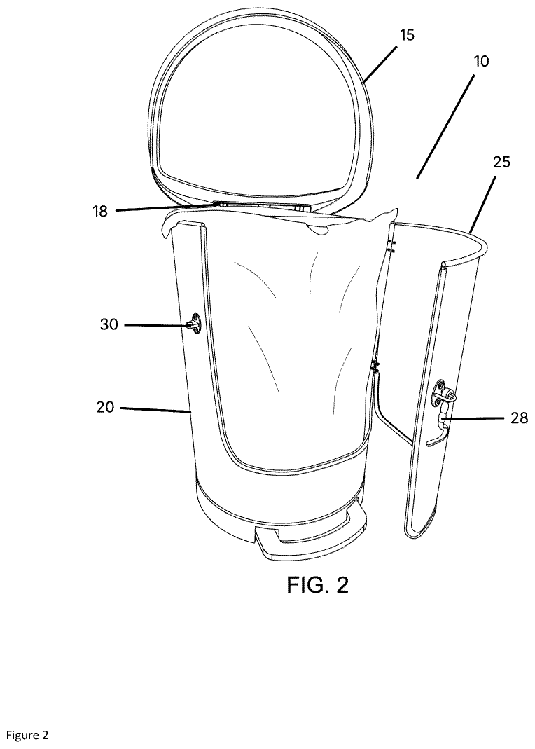

FIG. 2 shows a garbage can 10 equipped with a lid 15, illustrating an embodiment featuring a front-access design for improved usability. The lid 15 is connected to the body of the garbage can 10 via a connection 18, allowing it to be securely opened or closed as needed. The receptacle 20 serves as the main container for receiving waste materials, ensuring efficient containment within the garbage can 10.

The figure further includes a door 25 designed to facilitate improved access to the interior of the garbage can 10. The door 25 integrates into the front panel and opens independently from the lid 15, providing easy access for the removal of overfilled garbage bags. A hook closure 28 is attached to the door 25, securing it in a closed position when not in use by way of connecting with eye gate 30.

FIG. 2 further illustrates an eye gate 30, located on the side of the receptacle 20. This component serves as a locking or alignment mechanism when used in connection with hook closure 28, thereby providing enhanced stability and functionality of the door 25. The configuration of these elements within FIG. 2 demonstrates the adaptability of the garbage can 10 to various closure mechanisms, promoting effective usage in diverse settings.

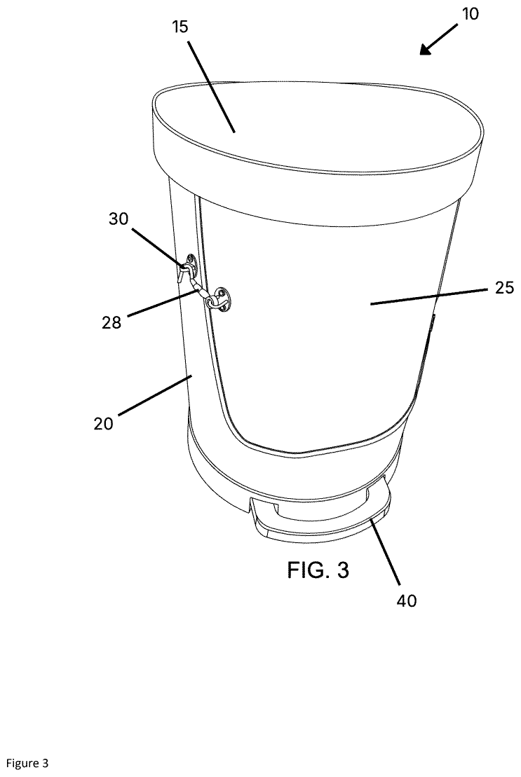

FIG. 3 shows the garbage can 10, featuring several key components designed to enhance convenience in garbage removal. The lid 15 is secured atop the receptacle 20, ensuring containment of the contents within the can. The receptacle 20 is configured to house and support garbage bags internally, accommodating flexible configurations of size and shape. It is noted that, although preferred, lid 15 is not required for proper functioning of door 25.

The door 25 is integrated into the front panel of the receptacle 20, providing direct access to the interior for simplified removal of garbage bags. The door 25 is equipped with a hook closure 28 and an eye gate 30 mechanism, which collaboratively secure the door in a closed position, thereby maintaining the integrity and cleanliness of the garbage can 10 when not in use.

Additionally, FIG. 3 illustrates a foot bar 40 positioned at the lower portion of the receptacle 20. The foot bar 40 facilitates hands-free operation, allowing users to open the door 25 with ease by engaging the foot bar 40 without the need to manually handle the door, thus improving the ergonomic function of the garbage can 10. The configuration of these elements collectively provides an improved solution for managing overfilled or heavy garbage bags with minimal effort. Of course, it is noted that foot bar 40 is not required for proper functioning of door 25.

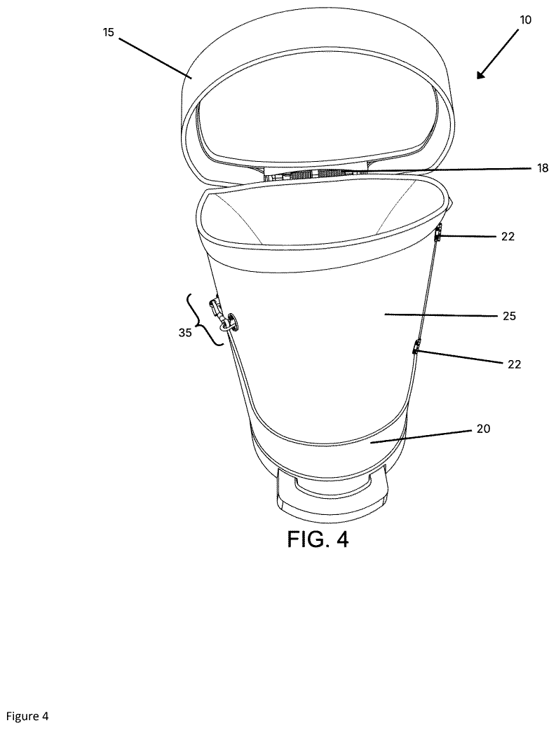

FIG. 4 shows the garbage can 10 equipped with a lid 15, which is connected to receptacle 20 via a connection 18. The connection 18 facilitates the opening and closing of the lid, providing access to the interior of the garbage can 10. The receptacle 20 forms the main body of the garbage can, providing a cavity for containing waste materials.

The garbage can 10 incorporates a front door 25, integrated into the front panel of the receptacle 20. This door is designed to provide access to the internal region, aiding in the removal of garbage bags, particularly those that are overfilled. The door 25 is supported by two hinges 22, allowing it to pivot open and closed. In other embodiments, door 25 may be supported by one hinge or more then two hinges depending on the configuration.

The door 25 is equipped with a door fastener 35, which serves to secure the door in a closed position, ensuring that the garbage can 10 remains sealed during non-use. The fastening mechanism may include various types such as a latch, magnetic closure, or friction fit, among others, depending on design preferences or application needs.

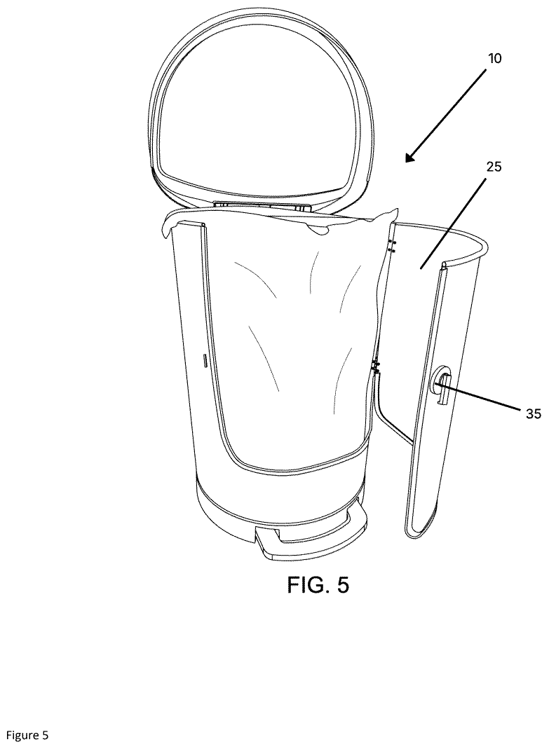

In an alternative embodiment, FIG. 5 shows garbage can 10 featuring an integrated front door mechanism for improved access. The door 25 is configured within the front panel of garbage can 10, allowing for enhanced removal of garbage bags. This arrangement facilitates direct access to the internal compartment, alleviating the challenges associated with extracting overstuffed bags from the top.

The door 25 is secured using door fastener 35, which may comprise various locking mechanisms such as a latch or magnetic closure. The positioning of door fastener 35 ensures that door 25 remains closed during non-use while providing ease of operation when access to the interior is needed.

Garbage can 10 may vary in design to accommodate diverse user needs, potentially featuring different shapes or sizes. This flexibility enables the adaptation of door 25 and door fastener 35 for various settings, including residential and commercial applications, thereby enhancing utility across different environments.

It will be appreciated by those skilled in the art that while the garbage can with front door for simplified bag removal has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A garbage can comprising:
a. a body having an internal region for containing refuse;
b. a front panel forming a portion of the body;
c. a door integrated into the front panel, the door configured to provide access to the internal region of the garbage can for the removal of a garbage bag.

2. The garbage can of claim 1, further comprising a closure mechanism for the door, the closure mechanism selected from the group consisting of a latch mechanism, a friction fit closure, a magnetic closure, and a loop-style closure.

3. A garbage can adapted for the ease of garbage bag removal, comprising:
a. a body defining an internal space for receiving refuse;
b. a front panel comprising a door, wherein the door is positioned to allow unobstructed access to the internal space;
c. means for maintaining the door in a closed position during non-use.

4. The garbage can of claim 3, wherein the means for maintaining the door in a closed position is selected from a group of mechanics, including a latch mechanism, a friction fit closure, a magnetic closure, and a loop-style closure.

5. A refuse container comprising:
a. a body with an interior space for holding refuse;
b. a front access panel, said panel including a hinged door configured to allow lateral access to the interior space;
c. a closure system for securing the hinged door in a closed position, whereby ease of refuse removal is facilitated.

6. The refuse container of claim 5, wherein the closure system is a magnetic closure.

7. The refuse container of claim 5, wherein the closure system is a latch mechanism.

8. The refuse container of claim 5, wherein the closure system is a loop-style closure.

9. The refuse container of claim 5, wherein the closure system is a friction fit.
